(19) United States
(12) Patent Application Publication
(10) Pub. No.: US 2014/0255139 A1
(43) Pub. Date: Sep. 11, 2014

(54) METHOD AND SYSTEM FOR TRANSPORTING CONTAINERS BY MODULAR AIRCRAFT

(71) Applicant: VOLIRIS, Yzeure (FR)

(72) Inventor: Alain Bernard, Paris (FR)

(73) Assignee: VOLIRIS, Yzeure (FR)

(21) Appl. No.: 14/348,941

(22) PCT Filed: Oct. 1, 2012
(86) PCT No.: PCT/IB2012/001926

§ 371 Date: Apr. 1, 2014

(30) Foreign Application Priority Data
Oct. 5, 2011 (FR) 1103019

(51) Int. Cl. B65G 63/00; B64B 1/00; B64B 1/02

(52) U.S. Cl. CPC B65G 63/004; B64B 1/02; B64B 1/005
USPC 414/572; 244/30

(57) ABSTRACT

Method for transporting containers in which a group of containers includes a subset M assigned to the transportation of goods and a subset V assigned to the transportation of a dismountable vehicle, wherein before it is shipped, the disassembled vehicle is loaded into the containers of subset V, between the originating handling facility and an intermediate handling facility, the group of containers which includes sub-groups M and V is transported by a first means of transportation, between the intermediate handling facility and the final handling facility, the container sub-group M is transported by the dismountable vehicle, and the dismountable vehicle being a modular multi-lift airship formed by modules that can be accommodated within the containers of group V.

### TECHNICAL FIELD OF THE INVENTION

The present invention relates to a method and system for transporting containers.

It also relates to an airship or aircraft suitable for transporting loads of a substantial weight to be shipped to poorly accessible sites, under economically advantageous conditions.

### STATE OF THE ART

Patent application WO 01/62631 discloses, especially in FIG. 8, the multiple possible modes of transportation between a starting point and an arrival point. Mention is made of the presence of intermediate sites, which allow the transported goods to be gathered so that they can be shipped quickly and efficiently to another intermediate site, which sites allow a large number of parcels to dispatched, with significant resources made available. Finally, between the last intermediate site and the end destination, a conventional mode of transportation, such as that of trucks, is used. This transport system, which is broken down in several steps, has several advantages. In addition, the collection of several parcels for the purposes of organizing large-scale transport makes it possible to avoid having to move multiple small vehicles carrying small loads. On the other hand, such a system requires the end destination to be easily accessible, and the necessary logistics to indeed be available at the last intermediate site.

Document US2004/0104304 describes an aircraft comprising a structure connected to two hulls. In one embodiment, the aircraft comprises a gondola and a propulsion system. In an alternative embodiment, the aircraft can be extracted from an ISO container, and inflated so as to be ready to be flown. In another alternative embodiment, the hulls are detachable for the transportation phase, so that an assembly step is required before takeoff. However, these different examples of modular aircraft do not solve the problems inherent to the transportation of containers in poorly accessible sites.

To overcome these different drawbacks, the invention provides various technical means.

### SUMMARY OF THE INVENTION

Firstly, a first object of the invention is to provide a method for transporting containers allowing poorly accessible delivery sites to be accessed either permanently or temporarily, for example following a natural disaster.

Another object of the invention is to provide a system for the transportation of containers allowing goods to be delivered in large quantities to sites that are not serviced by conventional modes of transportation such as road transport, train, or where no airport infrastructure is available.

Yet another object of the invention is to provide a fuel-efficient transport vehicle for transporting large loads.

Yet another object of the invention is to provide a mode of transportation that can be automated.

To this end, the invention provides a method for transporting containers from an originating handling facility to a final handling facility via an intermediate handling facility, in which a group of containers includes a subset M assigned to the transportation of goods and a subset V of containers assigned to the transportation of at least one dismountable vehicle intended for the transportation of containers from subset M between the intermediate handling facility and the final handling facility, wherein:
before it is shipped, the disassembled vehicle is loaded into the containers of subset V designed for this purpose;
between the originating handling facility and the intermediate handling facility, the group of containers which includes sub-groups M and V is transported by a first means of transportation (land-borne, seaborne or airborne);
at the intermediate handling facility, the vehicle is unloaded and assembled;
between the intermediate handling facility and the final handling facility, after the dismountable vehicle has been re-assembled, container sub-group M is transported by a second means of transportation including the dismountable vehicle, for shipping to the final handling facility;
the dismountable vehicle is a modular multi-lift aircraft formed by modules that can be housed in the containers of group V.

With such a method, it becomes possible to ship goods to locations or sites that are poorly accessible by conventional means of transportation. An intermediate handling facility can be set up very quickly on sites equipped with little or no handling equipment.

By multi-lift, is meant a modular airship whose lift is provided at least partially by a lighter-than-air gas contained in at least one lift volume (buoyancy). The one or more lift volumes comply with profiles generating lift in the presence of an airflow through which the one or more volumes penetrate (aerodynamic lift).

According to an advantageous embodiment, the modular multi-lift airship includes the following modules: at least one inflatable hull, at least one engine, one tail unit and a container-gripping module.

Advantageously, at least part of the modules forming the modular multi-lift airship are detachable from one another to allow the whole assembly to be stored in a plurality of containers.

In an alternative embodiment, the airship modules are housed in a single container. Such a container is advantageously of suitable dimensions. In addition, the use of a non-standard container, larger than the standard containers used for group M, has the advantage of facilitating the identification of a container which contains the airship, upon the arrival of a large quantity of containers in an intermediate handling facility.

Also advantageously, the modules are transformable (by disassembly and/or folding) between, on the one hand, a deployed and functional mode, and on the other hand, a storage mode allowing said modules to be placed within at least one container.

The invention also provides a system for transporting containers for implementing the aforementioned transportation method, including:
an originating handling facility;
an intermediate handling facility;
a final handling facility;
a container-gripping module;
a group of containers provided with at least two subsets:
   namely a subset M assigned to the transportation of goods and;
   a subset V assigned to the transportation of at least one dismountable vehicle;
a first means of transportation which can be used for transporting subsets M and V between the originating handling facility and the intermediate handling facility;
the dismountable vehicle being a modular multi-lift airship including the following elements: at least one inflatable hull, at least one engine and one tail unit;
said vehicle being usable for transporting elements of subset M, between the intermediate handling facility and the final handling facility.

Advantageously, the container-gripping module is a landing gear assembly which includes a plurality of gripper arms.

According to an alternative embodiment, the modular multi-lift airship also includes a gondola. In one advantageous embodiment, the gondola is comprised of a container.

According to yet another advantageous alternative, between the originating handling facility and the intermediate handling facility, the containers are transported by boat, train, plane, truck or the like, or a combination of several of these modes of transportation.

The invention also provides a modular airship which includes at least one inflatable hull, at least one engine, at least one tail unit, with the inflatable hull having substantially the shape of a lift generating profile under the influence of an airflow (preferably obtained when the aerostat is moving), said airship being modular, the inflatable hull and at least part of the modules being transformable between, on the one hand, a deployed and functional mode, and on the other hand, a storage mode allowing said modules to be placed within at least one container.

The containers may be of various preferably standardized types, dimensions and configurations. In one advantageous embodiment, containers of the ISO 668 type, also referred to as “forty-foot containers” are used.

Advantageously, at least some parts of the modules are detachable from one another to allow the whole assembly to be stored in a plurality of containers.

Advantageously, the one or more engines and the one or more tail units each form at least one module.

In one advantageous embodiment, the inflatable hull is formed from a plurality of modules.

According to another advantageous alternative, the inflatable hull comprises a plurality of longitudinal lobes. Each of the lobes may then comprise a dedicated skeleton and fabric.

According to yet another advantageous alternative, the modular airship is adapted to lift and move at least one standard container of the ISO 668 type by means of lift, generated in part by an airflow along the profile of the inflatable hull.

According to yet another alternative embodiment, the modular airship includes a container-gripping module.

### DESCRIPTION OF THE DRAWINGS

All embodiment details are given in the following description, with reference to FIGS. 1 to 8, presented solely for the purpose of non-limiting examples, and in which:

FIG. 1 is a schematic illustration of the method for transporting containers according to the invention;

FIG. 2 is a perspective view of an aircraft according to the invention;

FIG. 3 is a schematic illustration of a skeleton element for the airship FIG. 2;

FIGS. 4a and 4b are elevational views of the front part of the airship of FIG. 2, provided with a gondola (FIG. 4a) or of a container to be transported (FIG. 4b);

FIG. 5 shows an elevational cross-sectional view of the airship of FIG. 2, at the engine mounting portion;

FIG. 6 illustrates an elevational cross-sectional view of the airship of FIG. 2, at the tail unit mounting portion;

FIGS. 7a, 7b and 7c illustrate a tail unit example in the deployed (FIG. 7a) and folded (FIGS. 7b and 7c) modes;

FIGS. 8a, 8b and 8c illustrate an example of a container-gripping module before loading a container (FIG. 8a), after loading a container (FIG. 8b) and in a hanging position below the aircraft (FIG. 8c).

### DETAILED DESCRIPTION OF THE INVENTION

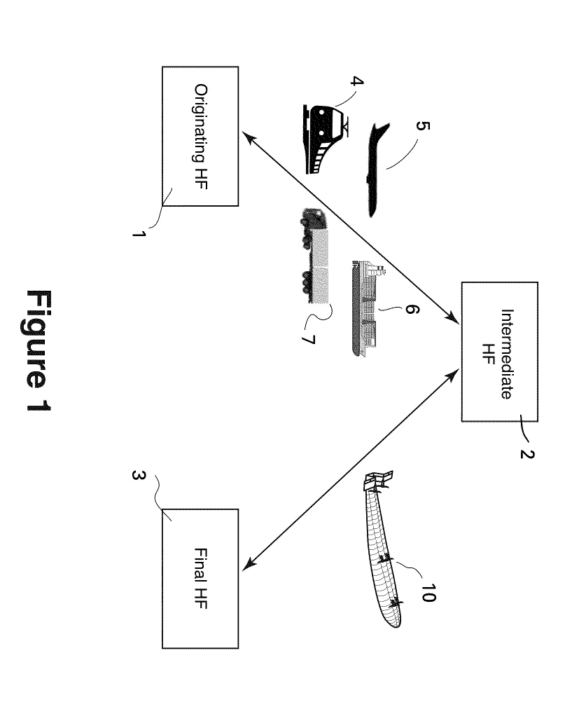

FIG. 1 is a schematic illustration of the method for transporting containers according to the invention. At least three handling facilities 1, 2, 3 are involved in the transportation of goods by means of containers intended to be shipped to a final destination 3.

The containers may be of various types and/or dimensions. In one advantageous embodiment, so-called “40-foot” containers are used. Such containers are standard and widely used in the industries of sea and rail transport as well as road transport companies. An ISO standard, (ISO-668) is provided to designate such types of container.

Between the originating handling facility 1 and the intermediate handling facility 2, the containers are transported by conventional means, by boat 6, train 4, plane 5, truck 7, or the like, or a combination of several of these modes of transportation. The containers carried to the intermediate handling facility 2 include two subsets, namely, a subset M assigned to the transportation of goods, and a subset V of containers assigned to the transportation of at least one dismountable vehicle 10. Vehicle 10 is described in greater detail below in the present description. The goods M are of any kind, and can be both raw materials and manufactured products, of any shape and size, able to be stored in the containers.

In a first transportation phase, the two subsets M and V are carried from the originating handling facility 1 to the intermediate handling facility 2 by one or several of the aforementioned modes of transportation. In a second transportation phase, the members of set M are carried from the intermediate handling facility 2 to the final handling facility 3 by means of the dismountable vehicle 10. Prior to this phase, the containers in which the vehicle modules are stowed are unloaded, and the vehicle modules are prepared and assembled.

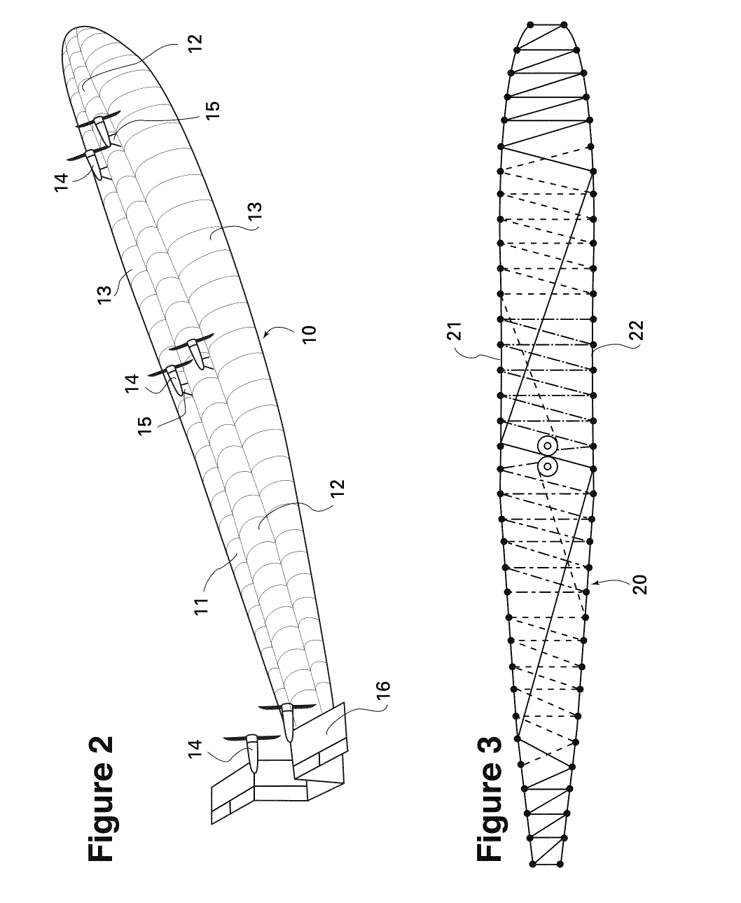

FIG. 2 shows an example embodiment of a modular aircraft according to the invention. In this example, the airship comprises three lobes 11, namely, a central lobe 12, topped with two side lobes 13. As shown in FIG. 6, the lobes are fluidly connected to each other, and form a single inflation chamber 24, which is closed by a removable and foldable hull or cloth 23. The longitudinal profile of the airship is generally elongated, similarly to a commercial airplane fuselage, and in the shape of an airplane wing profile, with a gradually decreasing height of the main end cross-section, except at the rounded nose. In this area, a dome-shaped profile is encountered, which is rounded at the front and widens away from the nose tip. Due to this wing-like profile and the presence of inflation chamber 24, the airship is provided with two sources of lift. Aerodynamic lift, created by an airflow on either side of the profile, and buoyancy produced by chamber 24 being filled with a lighter-than-air gas such as helium or hydrogen. The proportion of aerodynamic lift depends furthermore on the aerodynamic characteristics of the aircraft's profile and its velocity, in addition to the weight of the aircraft itself.

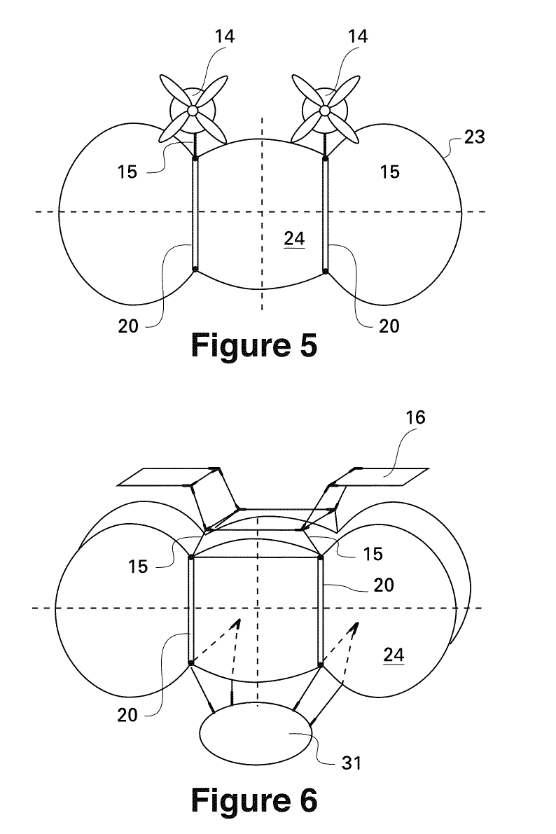

FIGS. 5 and 6 illustrate a cross-section of the airship, revealing an example of a profile formed by a three-lobe architecture. The airship is therefore substantially planar in shape.

A plurality of engines are advantageously distributed at different locations on the airship, such as on the tail unit, the middle portion and the front portion of the airship. Therefore, in the example shown in FIG. 2, six engines are positioned two by two in these three areas. These engines are used to drive propellers for the propulsion of the airship. The airship can be provided with combustion and/or electrical engines. The engine power and characteristics of the propellers and blades are established as a function of the envisioned load and desired performance. Solar sensors are advantageously arranged on the upper surface of the profile so as to generate at least part of the energy required for at least part of the engines and/or for actuating the flight controls and/or for supplying power to the instruments and various items of equipment.

An attachment 15 for engine 14, mounted so as to be removable, is provided for each engine. The engines can also be mounted on a tail unit.

At least one tail unit 16, mounted so as to be removable, is used to steer and control the airship, in a manner known per se. Control surfaces, of a known type, are provided on at least one tail unit.

As may be seen in FIG. 3, a skeleton example 20 is used for creating a structure which is both lightweight, sufficiently rigid and modular. In the example shown, skeleton 20 is designed for longitudinal arrangement, between side lobes 13 and central lobe 12, as shown in FIGS. 5 and 6.

A first spar 21 is arranged in the upper portion of the inflated hull in a normal flight position, extends longitudinally, substantially parallel to the axis of the central lobe 12. In a substantially symmetrical manner, a second spar 22, arranged in the lower portion of the inflated hull in a normal flight position, also extends longitudinally, in vertical alignment with the first spar. These two spars together form an elongate profile, similar to a wing profile. Spars 21 and 22 may be made of a metal alloy (aluminum, titanium or the like), of a composite (preferably fiber-loaded), or wood, according to the sizes considered and the strength requirements to be taken into account, and in accordance with the intended use of the airship. To ensure rigidity of the aircraft hull, spars 21 and 22 are preferably substantially rigid. Alternatively, at least one of the elements includes at least one so-called “flexible” area, having greater deformability characteristics than the so-called “rigid” areas.

The inner structure of the skeleton, between the two spars 21 and 22, is used to connect the two spars together, to ensure the rigidity of the overall structure, whilst using the lightest possible architecture. Alternatively, the spars are provided with a mounting so as to be movable with respect to each other, thereby allowing the volume of chamber 24 to be managed as a function of the different flight phases and airship loading.

Skeleton 20 is provided so that it can be stowed, in the storage mode, within a small volume such as that of a container. To allow for such a reduction in volume, the skeleton can either be dismountable, and/or foldable. Spars 21 and 22 are preferably mounted in several sections aligned end to end. Mounting can be telescopic or based on dismountable sections.

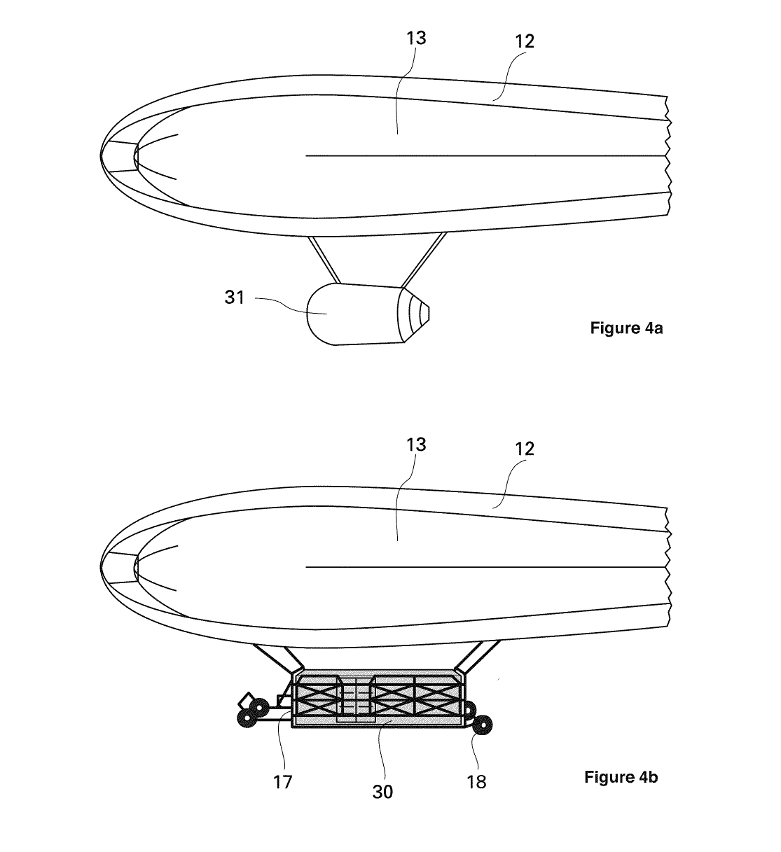

FIGS. 4a and 4b illustrate elevational views of a modular airship according to the invention, firstly in a configuration having a gondola 31 (FIG. 4a) and in a configuration for transporting a container 30 (FIG. 4b). In this configuration, a gripper module 17, attached below the central lobe 13 of the hull, houses a container 30 intended for the transportation of goods. The gripping module is described in more detail below in the present description. Container 30 is, for example, transported from an intermediate handling facility 2 to a final handling facility 3.

In another configuration, the gondola 31 can be used for transporting persons or objects between two handling facilities or between destinations of any kind. The gripping-module 17 can also be used to accommodate a gondola 31. In another alternative, the aircraft carries both a gondola and a gripping-module (with or without a container).

FIG. 5 is a schematic illustration of a cross-section of the modular airship 10 at an axial position corresponding to a location for the engines 14, which drive propellers in a rotary motion. Mounts 15 for the engines 14 are provided so that the engines 14 can be attached, in such a way that they can be dismounted, onto the skeleton elements 20 on either side of the central lobe 12. One or more bars or an elongated metal profile aligned along the same axis as that of the lobes can also be used for mounting one or more engines.

FIG. 6 is a schematic illustration of a cross-section of the modular airship 10 at an axial position corresponding to the location of tail unit 16. The latter is attached by means of removable mounts or one or more mounting profiles, preferably connected to skeleton 20, as shown in FIG. 6. Alternatively, such as illustrated in FIG. 2, the tail unit is positioned directly on the upper surface of the lobes.

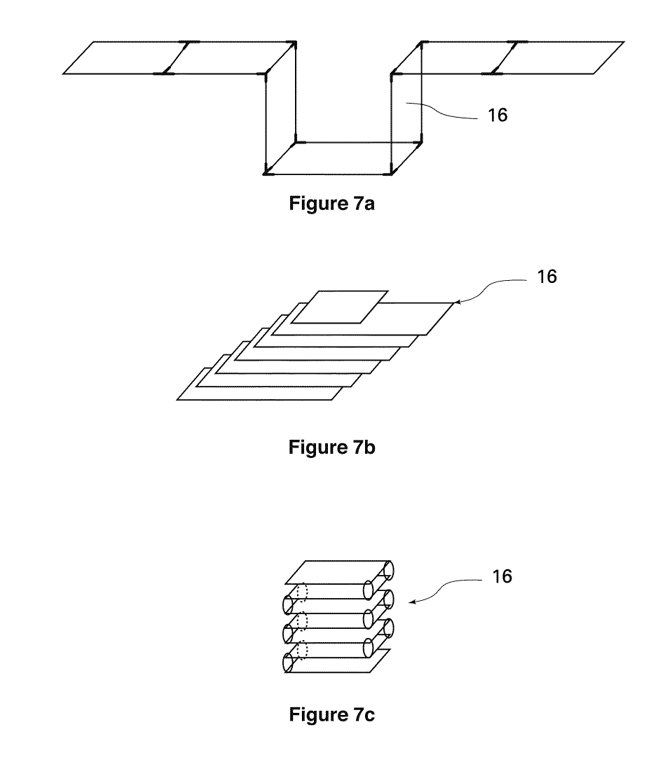

FIGS. 7a, 7b and 7c schematically show examples for the deployment of tail unit 16. In FIG. 7a, a tail unit example in the deployed modes is schematically shown. In this example, the tail unit comprises 7 flat surfaces connected to each other so as to form one U-shaped tail unit. These flat surfaces are provided to allow stowage within a reduced volume, either by means of consecutive folding between each of the flat surfaces, or by detaching the flat surfaces from one another. FIGS. 7b and 7c illustrate these two modes of stacking the flat surfaces of the tail unit.

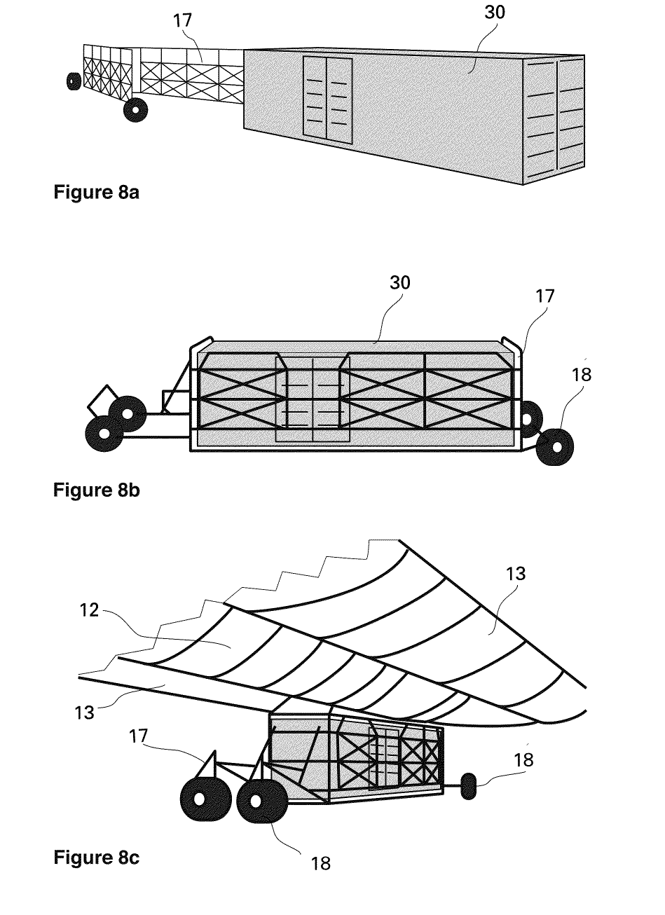

FIGS. 8a, 8b and 8c illustrate a series of perspective views of an example container-gripping module 17.

In FIG. 8a, the gripping-module is in an open position, to allow a container 30 to be inserted within the volume bounded by the module. FIG. 8b shows the container of FIG. 8a held by the gripping-module 17. The wheels 18 make it possible to ensure straightforward displacement of the whole assembly. These wheels 18 can also be used as the landing gear of the aircraft when the gripping-module 17 is attached below the lower surface of the lobes, as shown, for example in FIG. 4b and in FIG. 8c.

### IMPLEMENTATION EXAMPLE

The example involves the use of so-called forty-foot containers, whose maximum weight is thirty-three tons. If it were desired to lift such a container through the sole action of buoyancy, using helium or hydrogen, a volume of about 33,000 m³ would be required, in addition to the volume of approximately 45,000 m³, needed to carry the empty weight and fuel for the aerostat, in other words approximately fifteen additional tons. In the same scenario, when the container is released, the aerostat would lift off immediately since its weight would be reduced by its thirty-three ton load. To avoid this drawback, the vehicle according to the invention uses the aerodynamic lift of the hull to carry part of the payload and fuel, while remaining heavier than air when empty, so as to return to the ground naturally.

By way of example, a hull whose volume is in the range between 10,000 and 15,000 m³ can lift a thirty-three ton container and allow it to fly at approximately 100 km/h. Take-off can be performed on a very short runway of imperfect quality in comparison with that required by a conventional cargo aircraft for the transportation of a similar load.

The containers are arranged to be attached from above and are attached below the hull of the modular airship. Attachment is facilitated in an embodiment in which the engines and the tail unit are above the hull.

In an alternative embodiment, the landing gear is attached to the container by a device which can move the container on the ground. In another alternative embodiment, the airship is a drone which flies without a pilot, or by means of an autopilot, or through remote piloting by means of a remote control. In this example, the airship is composed of a hull inflatable with helium or hydrogen, which, as a result of its size, can be accommodated in a forty-foot container. The engines and the tail units, once disassembled, are accommodated in two other containers of the same size. A gripping-module, also serving as landing gear, is also accommodated in a container. Various ancillary items of equipment are also accommodated within one or more other containers. One of these containers contains the gondola or serves as the latter. Another container can be used as a base on the ground.

In an example embodiment of the method for transporting containers, a freighter ship delivers five V930 containers/1 to 5 and 12,000 m³ of bottled helium, or 150 racks of nine bottles each and a tank of 10,000 liters of fuel.

To assemble the modular aircraft, hull 23 is first spread out on the ground, and then inflated with air so that it can be equipped with its internal fittings, in particular its flexible fuel tanks. It is then deflated. The engines and engine pylons are mounted on top, together with the tail unit, antennas and control units. Straps maintain the hull on the ground. It is then inflated with helium, preferably at a time when there is no wind. The gripping-module grips the other base camp which is intended to serves as a cockpit and for the transportation of the team to the arrival point. The gripping-module is attached below the hull. The airship is then ready for a possible test flight.

After adjustment and calibration, the aircraft can carry part of the team to the landing point. Since this flight is piloted, it is possible to carry passengers, and members of the team. It is also possible to leave the team at the destination point together with the gondola, which then becomes the second base camp. The airship returns alone to its departure point and commuting trips may begin with containers with or without a payload. In order to exchange teams, it suffices to make one round trip with one of the base camps.

In an alternative concept, a container accommodates a flexible hull, its internal fittings (for example, a flexible fuel tank) and accessories needed for its assembly. In particular, flight management accessories can be provided (temperature and pressure sensors, valves, etc . . . ). In an advantageous alternative, elements to avoid depression of the hull's nose are used. The rigid or semi-rigid skeleton is accommodated in one or more containers.

Other equipment parts can also be provided, such as elements for controlling the hull's shape and its internal pressure during flight, elements for docking and attaching the nose of the aircraft to the ground, accessories for preparing the hull on the ground (coating to prevent damage to the hull on the ground, etc.).

Hull 23 can be folded and/or wound to fit within the container once folded. By way of example, a hull may be approximately 100 m long and 25 m wide when unfolded. The interior fittings and the different accessories are removable and/or retractable so that they can be integrated within a container.

Another container contains one or more engines needed for the propulsion of the aircraft, the corresponding propellers and their accessories, together with the accessories for mounting the engines on the hull.

The engines are selected such that their power is sufficient to permit movement of the airship. For example, engines ranging from a few hundred to a few thousand kW, depending on the lift of the airship, may be provided.

Another container accommodates the tail unit of the airship, together with the accessories for mounting the tail unit to the hull. The tail unit is disassembled into subsets adapted to be accommodated within the container. The different fixed and movable planes are easily disassembled, for the purposes of being integrated within the dedicated container. In an alternative embodiment, the tail unit is foldable: the dimensions of the folded tail unit are compatible with those of a container.

Yet another container accommodates the gripping-module with its landing gear, together with the accessories for hull mounting.

The gripping-module is dismountable and/or retractable to be accommodated within its container. In an alternative embodiment, the landing gear and the gripping-module are independent from each other.

Another container accommodates the gondola and the accessories for hull mounting. In an alternative embodiment, the container is itself used as a gondola. The dimensions of the gondola are such that it is accommodated in a container. In an alternative embodiment, the gondola is dismountable such that all of its subsets can be placed within the container.

All of the ancillary accessories (antennas, control units, holding straps, etc.) are integrated within one of the aforementioned containers, depending on the overall dimensions of each of these.

In an alternative embodiment, additional containers are used as a ground base and/or for transporting other hardware/equipment depending on mission specifics (fuel, gas reserve, etc.).

The Figures and descriptions above illustrate rather than limit the invention. In particular, the invention and its different alternative embodiments have been described above in relation to a specific example which includes two transport phases between three handling facilities.

Nevertheless, it is will be obvious to one skilled in the art that the invention can be extended to other embodiments in which, alternatively, it is provided that the containers of subset V intended for shipping the dismountable vehicle are transported in consecutive steps and/or from different sites.

The reference symbols in the claims are in no way limiting. The verbs “comprise” and “include” do not exclude the presence of elements other than those listed in the claims. The word “a” preceding an element does not exclude the presence of a plurality of such elements.

1. (canceled)

2. (canceled)

3. (canceled)

4. (canceled)

5. A system for transporting containers including:
an originating handling facility;
an intermediate handling facility;
a final handling facility;
a container gripping module;
a group of containers provided with at least two subsets:
namely a subset M assigned to the transportation of goods; and
a subset V assigned to the transportation of at least one dismountable vehicle;
a first means of transportation usable for transporting subsets M and V between the originating handling facility and the intermediate handling facility;
wherein the dismountable vehicle being is a modular multi-lift airship which includes the following elements: at least one inflatable hull, at least one engine and one tail unit;
wherein the modular airship further includes a container-gripping module attachable under the airship also serving as landing gear and for moving said containers using the landing gear wheels; and
where said vehicle is usable for transporting elements of subset M, between the intermediate handling facility and the final handling facility.

6. The transportation system of claim 5, wherein the container gripping module is a landing gear assembly which includes a plurality of gripper arms.

7. The transportation system of claim 5, wherein the modular airship also includes a gondola.

8. The transportation system of claim 7, wherein the gondola is comprised of a container.

9. The transportation system according to claim 5, wherein, between the originating handling facility and the intermediate handling facility, the containers are transported by boat, train, plane truck or the like, or a combination of several of these modes of transportation.

10. The transportation system of claim 5, wherein said gripping-module is adapted for taking an open position to allow a container to be inserted within the volume bounded by the module.

11. A modular airship comprising at least one inflatable hull, at least one engine, at least one tail unit, with the inflatable hull having substantially the shape of a lift generating profile under the influence of an airflow, said airship being modular, the inflatable hull and at least part of the modules being transformable between, on the one hand, a deployed and functional mode, and on the other hand, a storage mode allowing said modules to be placed within at least one container, wherein the modular aircraft further includes a container-gripping module attachable under the airship also serving as landing gear and for moving said containers using the landing gear wheels.

12. The modular airship of claim 11, in which said gripping-module is adapted for taking an open position to allow a container to be inserted within the volume bounded by the module.

13. The modular airship of claim 11, in which the container-gripping module is a landing gear assembly which includes a plurality of gripper arms.

14. The modular airship of claim 11, in which the container-gripping module is retractable.
